(19) United States
(12) Patent Application Publication
(10) Pub. No.: US 2026/0111546 A1
(43) Pub. Date: Apr. 23, 2026

(54) AUTOMATED FUNCTION-LEVEL CODE SIGNATURE GENERATION FOR WINDOWS-PE AND ELF MALWARE DETECTION

(71) Applicant: Palo Alto Networks, Inc., Santa Clara, CA (US)

(72) Inventors: Dongrui Zeng, Sunnyvale, CA (US); Benjamin Chang, Union City, CA (US); Yang Ji, San Jose, CA (US); Wenjun Hu, Santa Clara, CA (US)

(21) Appl. No.: 18/919,978

(22) Filed: Oct. 18, 2024

(51) Int. Cl. G06F 21/56

(52) U.S. Cl. CPC G06F 21/563; G06F 2221/033

(57) ABSTRACT

The present application discloses a method, system, and computer system for identifying function signatures that are used to detect certain types of malware. The method includes: (a) performing disassembly of a plurality of input binaries to generate a set of function signatures, (b) determining a ranking of function signatures for the set of function signatures, and (c) automatically selecting a subset of function signatures for detecting a type of file, wherein the subset of function signatures is selected based at least in part on the ranking of function signatures.

### BACKGROUND OF THE INVENTION

Malware detection is a critical aspect of modern cybersecurity. As cyber threats become increasingly sophisticated, there is a constant need for more advanced tools and methods to detect and mitigate malicious software. Traditional signature-based malware detection methods, which rely on predefined patterns of malicious code, often struggle to keep up with the rapid evolution of malware, particularly in environments where polymorphic and metamorphic techniques are employed to obfuscate malware signatures.

### BRIEF DESCRIPTION OF THE DRAWINGS

Various embodiments of the invention are disclosed in the following detailed description and the accompanying drawings.

FIG. 1 is a block diagram of an environment for providing security services for a network according to various embodiments.

FIG. 2 is a flow diagram for automatically selecting a set of signatures detecting malware according to various embodiments.

FIG. 3 is a flow diagram of a method for automatically selecting function signatures for classifying network samples according to various embodiments.

FIG. 4 is a flow diagram of a method for automatically selecting and deploying function signatures for classifying network samples according to various embodiments.

FIG. 5 is a flow diagram of a method for generating a set of function signatures for a set of samples according to various embodiments.

FIG. 6 is a flow diagram of a method for ranking function signatures according to various embodiments.

FIG. 7 is a flow diagram of a method for ranking function signatures according to various embodiments.

FIG. 8 is a flow diagram of a method for selecting function signatures for deployment according to various embodiments.

FIG. 9 is a flow diagram of a method for deploying a set of function signatures to perform network traffic classifications according to various embodiments.

FIG. 10 is a flow diagram of a method for deploying a set of function signatures to perform network traffic classifications according to various embodiments.

FIG. 11 is a flow diagram of a method for monitoring performance of a function signature for performing network traffic classifications after deployment according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a security entity may be a network node (e.g., a device) that enforces one or more security policies with respect to information such as network traffic, files, etc. As an example, a security entity may be a firewall. As another example, a security entity may be implemented as a router, a switch, a DNS resolver, a computer, a tablet, a laptop, a smartphone, etc. Various other devices may be implemented as a security entity. As another example, a security may be implemented as an application running on a device, such as an anti-malware application.

As used herein, malware may refer to an application that engages in behaviors, whether clandestinely or not (and whether illegal or not), of which a user does not approve/would not approve if fully informed. Examples of malware include trojans, viruses, rootkits, spyware, hacking tools, keyloggers, etc. One example of malware is a desktop application that collects and reports to a remote server the end user's location (but does not provide the user with location-based services, such as a mapping service). Another example of malware is a malicious Android Application Package. apk (APK) file that appears to an end user to be a free game, but stealthily sends SMS premium messages (e.g., costing $10 each), running up the end user's phone bill. Another example of malware is an Apple iOS flashlight application that stealthily collects the user's contacts and sends those contacts to a spammer. Other forms of malware can also be detected/thwarted using the techniques described herein (e.g., ransomware). Further, while malware signatures are described herein as being generated for malicious applications, techniques described herein can also be used in various embodiments to generate profiles for other kinds of applications (e.g., adware profiles, goodware profiles, etc.).

As used herein, a function signature may refer to a unique identifier or representation of a function's key characteristics, commonly used in programming, reverse engineering, and malware analysis. It captures essential elements of a function that distinguish it from others, allowing the function to be identified even when it has been reused, modified, or obfuscated. In the context of malware detection, function signatures are particularly valuable, as they help identify core behaviors of malware that remain consistent across different variants.

Various embodiments provide a method, system, and computer system for identifying function signatures that are used to detect certain types of malware. The method includes: (a) performing disassembly of a plurality of input binaries to generate a set of function signatures, (b) determining a ranking of function signatures for the set of function signatures, and (c) automatically selecting a subset of function signatures for detecting a type of file, wherein the subset of function signatures is selected based at least in part on the ranking of function signatures

Windows Portable Executable (PE) files are a common format used by malware targeting Windows operating systems. Malware authors frequently modify these files to avoid detection, requiring security systems to develop more adaptive methods to identify threats accurately. Effective detection of Windows PE malware often requires the ability to identify the underlying malicious functions within the executable code, rather than relying solely on static, file-level signatures.

Current malware detection systems often suffer from limitations in their ability to generalize across multiple malware variants while avoiding false positives in legitimate software (“goodware”). The challenge lies in creating function-level signatures that can provide accurate coverage for a wide range of malware samples without erroneously flagging benign software as malicious. Additionally, existing systems frequently lack automated processes for updating and optimizing the detection signatures over time, leading to reduced effectiveness as new malware emerges or existing signatures become obsolete.

Various embodiments provide a system capable of automatically generating and refining malware detection signatures at a function level for various file types, including Windows PE files and/or Linux ELF (Executable and Linkable Format) files. Such a system can incorporate clustering methods to group similar malware samples, enabling the generation of signatures that provide broad coverage across malware variants while minimizing false positives. Furthermore, the system can continuously monitor the performance of deployed signatures and replace any that are ineffective or lead to false positives, ensuring a high level of detection accuracy over time.

Various embodiments provide a system and method for automatically generating, selecting, and deploying malware detection signatures for Windows PE files and/or Linux ELF files at a function level. The system clusters malware samples based on code similarity, disassembles the code to analyze function-level behavior, and generates a set of signatures that provide optimal coverage for the malware sample set.

The present invention relates to a system and method for automatically generating, selecting, and deploying malware detection signatures, specifically at the function level, for Windows PE files and/or Linux ELF files. The system and/or technique used by various embodiments is designed to improve the accuracy and efficiency of malware detection by creating adaptive, function-level signatures that can provide broad coverage across malware samples while minimizing false positives when tested against goodware.

The system comprises several core components that work together to accomplish these goals. First, the system collects (e.g., by using a malware sample input module) a set of malware samples in the form of certain file types, such as Windows PE files and/or Linux ELF files. These samples may be obtained from various threat intelligence sources (e.g., inline security entities, a cloud security service that provides security services to inline security entities, et.) or internal malware repositories. After collection, the system clusters (e.g., using a clustering module, etc.) clusters the malware samples based on their code similarities, such as opcode sequences, control flow graphs (CFGs), or function call trees. This clustering groups malware samples that share similar code features, which enables the system to generate generalized signatures capable of detecting multiple variants of malware.

Once the malware samples are clustered, the system disassembles (e.g., using uses a disassembly and code analysis module, etc.) each sample into its constituent functions using static analysis techniques. The system extracts key features from the disassembled code, such as opcode sequences, control flow, and function calls. The system (e.g., using a function signature generation module, etc.) then generates candidate function-level signatures based on the disassembled data. These signatures capture patterns in the malware's core functionality, which tend to remain consistent across variants, making them reliable indicators for detection.

After generating these candidate signatures, the system (e.g., using a signature ranking module, etc.) ranks the candidate signatures. The ranking is based on several criteria, including the signature's ability to detect multiple malware samples (coverage), its uniqueness (to ensure it does not match benign programs), and its complexity (to avoid overly simplistic or overly complex signatures). This ranking allows the system to select an optimal set of signatures that balance malware detection with the minimization of false positives.

To further ensure accuracy, the system (e.g., using a goodware testing module, etc.) to test the selected signatures against a broad set of known goodware samples. Any signatures that generate false positives during this process are flagged and replaced. For example, the system can use a signature replacement module to implement the replacement process, during which the system selects alternative signatures from the ranked pool to maintain malware coverage without compromising accuracy. The goal is to refine the signature set until no false positives remain when tested against the set of goodware samples.

Once the final set of signatures is optimized, they are deployed by the system (e.g., using a signature deployment module, etc.) to security entities such as firewalls, intrusion detection systems (IDS), or antivirus software. These signatures are then used to scan network traffic and files, providing real-time malware detection. However, the system can be configured to further monitor and refine the deployed signatures. For example, the system (e.g., via a performance monitoring and feedback module, etc.) continuously monitors the deployed signatures in real-world environments. If a signature begins to underperform or generate false positives, it is automatically deactivated, and a new signature from the ranked pool is selected and deployed as a replacement. This ensures the system remains effective even as malware evolves.

The technique according to various embodiments (which can be implemented by a system and/or method) provides several key advantages. By automating the process of generating malware signatures, it greatly reduces the need for manual intervention, speeding up the detection of new threats. The system's focus on function-level signatures allows it to detect core malware functionalities that persist across different variants, resulting in more accurate and adaptable detection. Additionally, the clustering of malware samples allows for the generation of generalized signatures, which can detect multiple variants of a malware family, reducing the overall number of signatures needed. The rigorous testing against goodware minimizes false positives, enhancing the system's reliability. Finally, the continuous monitoring and updating of deployed signatures ensure that the system remains effective as the threat landscape evolves, with underperforming signatures automatically replaced in real-time.

In summary, the system provides a robust and automated solution for detecting Windows PE malware and/or Linux ELF malware through function-level signatures. By providing broad coverage across malware variants, minimizing false positives, and continuously updating itself, the system ensures a high level of malware detection accuracy while adapting to the constantly changing nature of cyber threats.

The principles of this invention, while described in the context of detecting malware in Windows Portable Executable (PE) files and/or Linux ELF files, can be readily extended to other file types commonly exploited by malware. The system's core functionality—clustering based on code similarity, disassembly into functions, and the generation of function-level signatures—is adaptable to other executable formats, such as Android APK files, etc. For example, the techniques described herein can be extended to file types sharing structural similarities with PE files, including well-defined sections of code and data that can be analyzed and broken down into functional components. By adjusting the disassembly techniques and signature generation process to account for the unique features of these formats, the system can effectively generate malware detection signatures for them.

Beyond executables, the system could also be extended to file types that execute scripts or macros, such as Microsoft Office documents containing malicious macros or PDF files with embedded scripts. In these cases, the system (e.g., the clustering and disassembly modules, etc.) would focus on analyzing the embedded script or macro code, generating signatures based on malicious behavioral patterns found within the script. The system's ability to generalize and refine signatures through automated ranking and goodware testing ensures that it could be applied to various file types, providing robust malware detection across a wide range of formats in different environments.

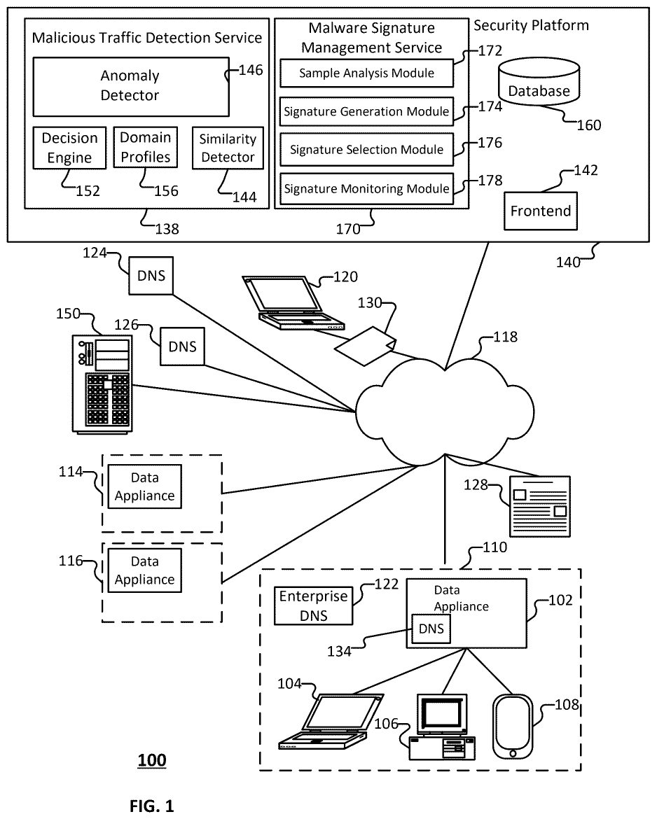

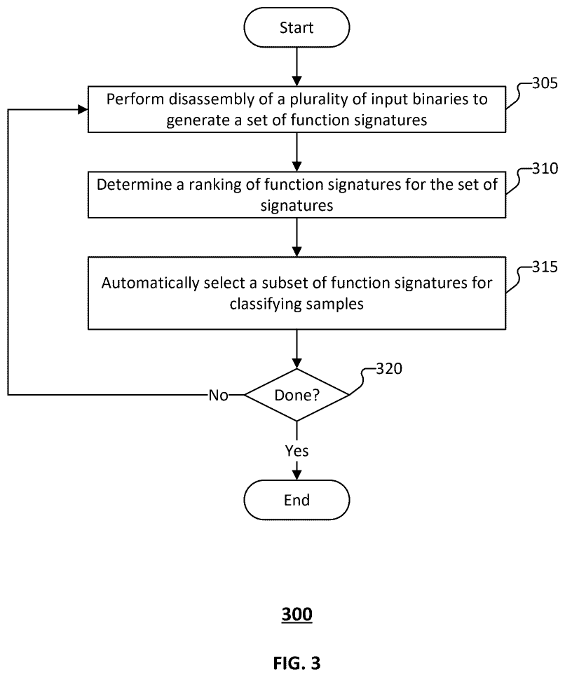

FIG. 1 is a block diagram of an environment for providing security services for a network according to various embodiments. In various embodiments, system 100 is implemented in connection with one or more of processes 300-1100 of FIGS. 3-11.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively block traffic, such as traffic to malicious domains, DNS hijacked domains, or stockpiled domains, or such as traffic for certain applications (e.g., SaaS applications). In some embodiments, data appliance 102 is also configured to enforce policies with respect to traffic that stays within (or from coming into) enterprise network 110.

Techniques described herein can be used in conjunction with a variety of platforms (e.g., desktops, mobile devices, gaming platforms, embedded systems, etc.) and/or a variety of types of applications and/or file types (e.g., Android. apk files, iOS applications, Windows PE files, Linux ELF files, Adobe Acrobat PDF files, Microsoft Windows PE installers, etc.). In the example environment shown in FIG. 1, client devices 104-108 are a laptop computer, a desktop computer, and a tablet (respectively) present in an enterprise network 110. Client device 120 is a laptop computer present outside of enterprise network 110.

Data appliance 102 can be configured to work in cooperation with remote security platform 140. Security platform 140 can provide a variety of services, including classifying domains (e.g., predicting whether a domain is a malicious domain, etc.), detecting DNS tunneling traffic, detecting malicious traffic, classifying network traffic, detecting malware (e.g., malicious files), generating signatures for network traffic (e.g., function signatures for files, etc.), providing a mapping of signatures to certain files (e.g., a mapping of signatures to benign files, a mapping of signatures to malicious files, etc.), providing a mapping of signatures to certain domains or DNS records (e.g., a domain for which a predicted likelihood that the record is a malicious domain exceeds a predefined likelihood threshold, etc.), performing static and dynamic analysis on malware samples, monitoring new domains and new DNS records (e.g., detecting new domains for which a certificate is issued/generated), assessing maliciousness of domains, providing a list of signatures of known exploits (e.g., malicious input strings, malicious files, malicious domains, etc.) to data appliances, such as to data appliance 102 as part of a subscription, detecting exploits such as malicious input strings, malicious files, malicious domains (e.g., an on-demand detection, or periodical-based updates to a mapping of domains to indications of whether the domains are malicious or benign), providing a likelihood that a network traffic sample or network activity is malicious or benign, providing/updating a whitelist of input strings, files, or network traffic samples or network activities deemed to be benign, providing/updating input strings, files, or domains deemed to be malicious, identifying malicious input strings, detecting malicious input strings, detecting malicious files, predicting whether input strings, files, or domains are malicious, providing an indication that an input string, file, domain, network traffic samples or network activities is malicious (or benign). In some embodiments, services provided by security platform 140 additionally comprise simulating DNS tunneling attacks/campaigns or relayed DNS tunneling attacks/campaigns, and/or training classifiers (e.g., training machine learning models), such as to be used to provide detection of malicious domains or detection of relayed DNS tunneling attacks.

In some embodiments, security platform 140 classifies a network traffic sample obtained from a security entity, such as a firewall. Security platform 140 may determine a predicted maliciousness classification for the network traffic sample and provide an indication (e.g., a report) to the security entity of whether the network traffic sample is malicious (or benign). Security platform 140 may determine the predicted maliciousness classification in contemporaneous (e.g., in real-time) with receiving the network traffic sample. In response to determining the maliciousness classification for a network traffic sample, the system can perform an action based at least in part on the maliciousness classification.

In some embodiments, security platform 140 manages security services provided for a network, such as by managing or providing services to network security entities. Security platform 140 can manage deployment of signatures, such as function signatures, to be used to classify files (e.g., intercepted traffic). In some embodiments, the signatures are used to detect malware. For example, security platform 140 detect malware using the signatures (e.g., in response to a classification/detection request from a network node such as an inline security entity) or by providing the signatures to inline security entities to perform inline (e.g., real-time) detection of malware such as malware embedded in network traffic intercepted by the inline security entity. Security platform 140 can generate a set of signatures that are associated with characteristics of a set of malware, and select a subset of those signatures to detect malware.

Examples of actions that can be performed by the security platform 140 in response to and/or based at least in part on the maliciousness classifications include, without limitation, (i) generating a report indicating the maliciousness classification and optionally or additionally providing further explanation for the maliciousness classification or context information associated with the network traffic sample; (ii) updating a whitelist or blacklist of network traffic samples or combinations of sets of requests (or commands) and corresponding responses, etc. ; (iii) providing a whitelist of signatures corresponding to benign files, (iv) providing a blacklist of signatures corresponding to malicious files (e.g., malware), and (v) providing an alert to an administrator, etc. Various other actions may be implemented. Security platform 140 can perform one or more of the actions.

Examples of actions that can be performed by the security entity in response to and/or based at least in part on the maliciousness classifications (e.g., in response to receiving the maliciousness classification include, without limitation, (i) handling the traffic according to the maliciousness classification, (ii) enforcing a predefined security policy, (iii) alerting a network node associated with the corresponding network activity, (iv) updating a whitelist or blacklist of network traffic samples or combinations of sets of requests (or commands) and corresponding responses, etc. Various other actions may be implemented. The security entity can perform one or more of the actions.

In some embodiments, a security entity, such as data appliance 102, intercepts network traffic. In response to intercepting the network traffic, the security entity determines whether to send a network traffic sample for the corresponding network activity (e.g., network activity associated with a session) to security platform 140 for analysis (e.g., to obtain a maliciousness classification).

In some embodiments, security platform 140 manages a set of signatures, such as function signatures, for detecting malware. The managing the set of signatures can include one or more of (a) collecting malware, (b) identifying malware families (e.g., performing a clustering of malwares), (c) disassembling malware samples, (d) generating function signatures for malware samples, (e) evaluating the generated function signatures, (f) selecting a set of function signatures (e.g., choosing an optimal set of function signatures for performing malware detection), (g) deploying the selected set of function signatures, (h) monitoring deployed function signatures, and/or (i) updating the set of deployed function signatures.

One of the primary components of a function signature is the function name, if it is available. However, in many cases, particularly with compiled or obfuscated code, function names may be stripped or altered, making other aspects of the function more critical for identification. Another key aspect of a function signature is the parameter information, which includes the number and types of input parameters that the function accepts. These parameters could be data types like integers, pointers, or arrays. Similarly, the return type of the function, which defines what type of value is returned (such as int or void), is also part of the signature.

In addition to parameters and return types, the calling convention is an important component. This convention specifies how arguments are passed to the function and how the return value is passed back, and it can vary between different architectures or programming environments. Beyond these structural elements, the function's control flow or opcode sequence, essentially the series of instructions that make up the function's internal logic, plays a significant role. These instruction patterns are particularly useful when function names and parameter details are unavailable, as is often the case with compiled or malicious code.

In malware analysis, recognizing function signatures is crucial. Many pieces of malware reuse common routines, such as encryption libraries or file manipulation code. While attackers may alter other parts of the malware to evade detection, core functionalities reflected in the function signature often remain unchanged. This makes function signatures a powerful tool for identifying malware based on its behavior, even when the exact code has been altered or recompiled to evade detection techniques. By focusing on these consistent behavioral elements, system 100 more reliably detect and classify malware across different variants and obfuscations.

In various embodiments, results of analysis (and additional information pertaining to applications, domains, etc.), such as an analysis or classification performed by security platform 140, are stored in database 160. In various embodiments, security platform 140 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+Gigabytes of RAM, and one or more Gigabit network interface adapters) that runs commercially available virtualization software, such as VMware ESXi, Citrix XenServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remaining portions of security platform 140 provided by dedicated hardware owned by and under the control of the operator of security platform 140.

According to various embodiments, security platform 140 comprises malicious traffic detection service 138 and/or malware signature management service 170. Security platform 140 may include various other services/modules, such as a malicious file detector, a malicious traffic detector, a parked domain detector, a DNS hijacked domain or DNS record detector, an application classifier or other traffic classifier, etc. Malware signature management service 170 is used in connection with automatically managing, determining, and/or deploying function signatures for detecting malware (e.g., malware of certain file types, such as Windows PE files, Linux ELF files, etc.).

Malicious traffic detection service 138 may comprise an anomaly detector 146 (e.g., configured to detect anomalies in network traffic, file samples obtained by intercepting traffic, DNS traffic, or DNS records, etc.), a decision engine 152 (e.g., configured to predict whether network traffic, intercepted file samples, DNS traffic is malicious or whether a DNS record is DNS hijacked), domain profiles 156, and/or a similarity detector 144. In some embodiments, malicious traffic detection service 138 detects malicious network traffic or malware obtained from intercepted network traffic (e.g., by classifying a file sample obtained by a security entity or other network node requesting a maliciousness classification).

Malicious traffic detection service 138 can determine the classification for network traffic (e.g., a file sample obtained from network traffic, a DNS record, a DNS query, a DNS response, etc.) based at least in part on querying a classifier(s). The classifier that is queried to provide a classification of the network traffic sample associated with the network activity is a fingerprinting-based classifier, a heuristics-based classifier, another rule-based classifier, and/or a machine-learning based classifier. The classifier may be trained based at least in part on historical samples (e.g., samples of network traffic samples extracted from network traffic). The classifier can be trained based at least in part on a machine learning process. Examples of machine learning processes that can be implemented in connection with training the classifier(s) include random forest, linear regression, support vector machine, naive Bayes, logistic regression, K-nearest neighbors (KNN), decision trees, gradient boosted decision trees, K-means clustering, hierarchical clustering, density-based spatial clustering of applications with noise (DBSCAN) clustering, principal component analysis, a neural network (NN), XGBoost, a convolutional neural network (CNN), and LLM etc. In some embodiments, the classifier implements a CNN.

According to various embodiments, security platform 140 (e.g., malware signature management service 170) automatically determines function signatures, deploys certain function signatures, and monitors and/or updates deployed function signatures.

In some embodiments, security platform 140 (e.g., malware signature management service 170) manages function signatures for performing malware detection. Malware signature management service 170 collects malware samples, analyzes the malware samples, and generates function signatures for the malware samples (e.g., to detect the same or similar malware samples). Malware signature management service 170 may additionally evaluate the generated function signatures, select a set of generated function signatures for deployment, determine a manner in which a particular signature is to be deployed, deploy the selected set of function signatures. In some embodiments, malware signature management service 170 monitors deployed function signatures, such as to detect whether a particular function signature(s) is causing a false positive malware detection. Malware signature management service 170 may update the set of deployed function signatures, such as by replacing (or attempting to replace) those deployed function signature(s) causing false positive malware detections.

In some embodiments, malware signature management service 170 comprises one or more of sample analysis module 172, signature generation module 174, signature selection module 176, and/or signature monitoring module 178.

Sample analysis module 172 is implemented to automatically obtain (e.g., collect) a set of files for which one or more function signature(s) are to be determined. In order for security platform 140 to generate function signatures for detecting malware, sample analysis module 172 collects (e.g., obtains) a diverse set of malware samples from various sources to ensure comprehensive coverage of different malware behaviors and techniques. These samples can be gathered from one or more of threat intelligence platforms, malware databases, security research forums, and honeypots designed to attract malicious actors. The collected samples may include known malware strains, such as trojans, worms, ransomware, and zero-day exploits, to provide a wide range of malicious functionality for analysis. In some embodiments, once gathered, the samples are carefully curated (e.g., manually by a domain expert or automatically based on a file analysis such as a dynamic analysis of the file in a sandbox). The collected samples may be categorized based on their behavior, attack vectors, and target systems. In some embodiments, before sample analysis module 172 analyzes the malware samples, each sample undergoes rigorous validation to confirm its authenticity and relevance, for example, to ensure the malware sample dataset is both representative of current threats and suitable for extracting meaningful function signatures. This malware sample dataset can serve as the foundation for training the system to identify common patterns and generate reliable function signatures that can later be used for detecting similar malicious activities in real-time.

In some embodiments, sample analysis module 172 determines the malware sample dataset based on collecting malware from intercepted network traffic and identifying those malware samples for which no deployed function signature was able to generate a detection (e.g., sample analysis module 172 identifies the malware samples that evaded detection by system 100, etc.). The malware collected from intercepted network traffic may be obtained from inline security entities. An inline security entity may provide the malware samples according to a predefined schedule, in batches, and/or in connection with requesting a real-time classification from security platform 140.

In response to collecting the set of files, sample analysis module 172 analyzes the set of files, such as by determining one or more characteristics associated with the set of files. In some embodiments, sample analysis module 172 clusters the malware sample dataset to obtain a set of clusters. Various clustering techniques may be implemented to obtain the set of clusters. As an example, the malware sample dataset can be clustered according to code similarity.

In some embodiments, to cluster the malware sample dataset before generating function signatures, the process begins with feature extraction. Sample analysis module 172 analyzes each malware sample in the malware sample dataset to identify key characteristics that can help differentiate it from others. These features can include both static properties—such as file size, hash values, and imported libraries—and/or dynamic behaviors observed when the malware is executed in a controlled environment, such as system calls, file modifications, registry changes, and network communications. A dual approach of using both static properties and observed dynamic behaviors captures both the structural and functional aspects of each malware sample, providing a rich dataset for clustering.

Once the features are extracted, sample analysis module 172 can reduce the complexity of the data. Malware datasets can be high-dimensional, making it difficult to compare samples efficiently. Sample analysis module 172 can apply techniques such as Principal Component Analysis (PCA) or t-SNE to reduce the dimensionality of the dataset while retaining the most important features. This step ensures that the clustering process is performed on a manageable number of features, focusing on those that are most relevant for distinguishing between different types of malware. This also enhances the accuracy and efficiency of the subsequent clustering process.

With the key features extracted and dimensionality reduced, the malware samples are ready to be clustered. Sample analysis module 172 can implement various clustering techniques, for example by applying clustering algorithms such as k-means, hierarchical clustering, or DBSCAN, etc. These clustering algorithms group the malware samples based on their similarity, using metrics like Euclidean distance or cosine similarity between feature vectors. Samples that exhibit similar behavioral patterns or structural characteristics are placed into the same cluster, while those that are dissimilar are grouped separately. This results in clusters that represent distinct families or types of malware, which share commonalities such as their method of attack or code base.

Sample analysis module 172 can analyze the clusters to understand the shared characteristics of the malware samples within each group. Each cluster likely represents a specific category of malware, such as ransomware, spyware, or remote access trojans. By identifying these common traits, malware signature management service 170 (e.g., signature generation module 174) can focus its efforts on generating function signatures that represent the behavior of the entire cluster, rather than individual samples. This approach can significantly streamlines the process of signature generation and enhances detection accuracy. According to various embodiments, by clustering malware samples before generating signatures, the system is able to capture the broader patterns of malicious behavior, allowing for more efficient and effective detection of similar malware in the future.

Malware signature management service 170 signature generation module 174 to generate signatures for the malware sample dataset. In some embodiments, signature generation module 174 generates function signatures for each cluster in the set of clusters that are identified in the malware sample dataset. In some embodiments, signature generation module 174 generates function signatures for each malware sample in the malware sample dataset.

In some embodiments, signature generation module 174 generates function signatures for malware samples by analyzing both the static structure and dynamic behavior of each sample in the dataset. Once the malware samples have been clustered into groups based on their similarities, the system focuses on extracting specific functions that are indicative of malicious behavior. As an example, the function signatures are designed to capture the core operations and logic performed by the malware, such as how the malware communicates with command-and-control servers, manipulates system resources, or exploits vulnerabilities.

To begin, the system (e.g., signature generation module 174 or sample analysis module 172) deconstructs the malware's executable code by disassembling or decompiling it, for example, by breaking it down into individual functions and subroutines. During this stage, the system identifies key components such as system calls, API functions, and control flow structures that define how the malware operates. Signature generation module 174 analyzes these functions to determine their role in the malware's execution, for instance, whether they handle file encryption, network communication, or privilege escalation. This step allows the system (e.g., signature generation module 174) to isolate the functions that are most relevant to the malicious activity of the malware.

In some embodiments, the system (e.g., signature generation module 174 or sample analysis module 172) also executes (e.g., in parallel) the malware in a sandbox environment, where it can observe the real-time (e.g., dynamic) interactions of the malware with the operating system and network without causing harm. During execution, the system monitors all interactions with the file system, memory, network, and operating system APIs. By correlating these behaviors with the disassembled functions, the system is able to link specific actions-such as attempting to disable security services or exfiltrate data-to the underlying code. The dynamic analysis can provides context for the static code, revealing how the malware behaves in various environments and under different conditions.

In some embodiments, once both static and dynamic analyses are complete, the system (e.g., signature generation module 174) generates function signatures by abstracting the unique traits of the identified functions. These signatures can represent the behavior or pattern of operations that are specific to the malware's functionality, rather than just its raw code. A function signature may include sequences of system calls, memory usage patterns, or data flow patterns that are characteristic of a particular malware family. By focusing on these behavioral patterns, the signatures are robust against minor variations or obfuscation techniques used by attackers to disguise their malware.

The function signatures can then stored in a database and used to detect future malware threats (e.g., after selection and performance analysis). Because these function signatures can be based on the core functions of the malware, the system can use the function signatures recognize new variants or similar threats that exhibit the same underlying behavior, even if the malware's external features, such as file size or encryption, have changed. According to various embodiments, the use of the automatic generation, selection, and deployment of function signatures allows the system (e.g., security platform 140, etc.) to continuously evolve and detect not only known threats but also new and modified malware samples, providing a proactive defense against cyber-attacks.

Malware signature management service 170 uses signature selection module 176 to select function signatures to deploy, such as to deploy in the wild to provide real-time detections or to otherwise be used in connection with determining how to handle network traffic (e.g., to determine whether/how a security policy is to be enforced). Before selecting a subset of function signatures for deployment, signature selection module 176 can determine a set of candidate function signatures, which signature selection module 176 can further evaluate for deployment selection.

In some embodiments, signature selection module 176 determines the set of candidate function signatures based at least in part on determining characteristics pertaining to the function signatures in the set of function signatures. Examples of function signature characteristics may include a number of unique malware hits (e.g., a number of unique malware detections made by the function signature with respect to the malware sample dataset from which the function signatures are determined), a function signature length, etc. Various other characteristics may be implemented. Signature selection module 176 can select the candidate function signatures based at least in part on one or more function signature characteristics.

In some embodiments, signature selection module 176 selects the candidate function signatures based at least in part on a predefined scoring function. The predefined scoring function can be used to score the function signatures based on one or more function signature characteristics. For example, the predefined scoring function may associate different weights to different function signature characteristics and signature selection module 176 can compute a score for the function signature.

In some embodiments, signature selection module 176 selects the candidate function signature(s) based at least in part on the number of unique malware hits (e.g., a number of unique malware detections made by the function signature with respect to the malware sample dataset from which the function signatures are determined). For example, signature selection module 176 ranks the function signatures of the set of generated function signatures based on the number of unique malware hits. Signature selection module 176 selects a highest ranked function signature(s) as a candidate function signature. For example, signature selection module 176 selects a predefined number of the highest ranked function signature(s) as candidate function signatures. In some embodiments, the system uses the number of unique malware hits to select candidate function signatures because it is desirable to have the largest breadth of detections (e.g., number of uniquely hit/detected samples) by using the smallest number of function signatures to perform the detections because the more the function signatures used in scanning/performing detections, the greater the computational cost for scanning network traffic.

According to various embodiments, signature selection module 176 iteratively (a) selects a next highest ranked function signature as a candidate function signature, (b) evaluates the selected candidate function signature against a goodware dataset (e.g., performs a retrospective scanning of a high-priority goodware), (c) determines whether the selected candidate function signature resulted in a false positive detection with respect to any goodware samples in the goodware dataset, (d) either discards the selected candidate function signature and begins a next iteration, or stores the candidate function signature as a candidate for deployment and determines whether additional candidate function signature are to be selected. If the selected candidate function signature results in a false positive detection the selected candidate function signature is discarded and signature selection module 176 begins the next iteration. Conversely, if the selected candidate function signature does not result in a false positive, signature selection module 176 determines a malware cluster coverage (e.g., signature selection module 176 tests the coverage that the selected candidate function signature provides in performing detections of the malware sample dataset used to generate the function signatures). If the selected candidate function signature (in addition to any previously selected and evaluated function signatures that were not discarded) provides sufficient coverage of the malware sample dataset (e.g., the set of malware clusters is fully covered) then the candidate function signature is stored in a signature set (e.g., is deemed a function signature for deployment). However, if the selected candidate function signature does not provide sufficient coverage, the candidate function signature is stored in a signature set and signature selection module 176 begins another iteration of selecting a function signature that is a candidate for deployment.

In some embodiments, the godoware dataset against which the selected candidate function is selected comprises a set of high priority goodware. As an example, the set of high priority goodware may comprise: (a) known benign samples obtained through interception of network traffic, and (b) known benign samples from third party sources, such as publicly available sources/datasets. The known benign samples obtained through interception of network traffic may comprise benign samples obtained based on classifying intercepted network traffic for a customer (e.g., a cloud security service can determine classifications of files, or network traffic generally), where such customer benign samples are within the predefined retention period for the system (e.g., the cloud security service) at the time of testing. The use of known benign samples retained within the system's retention period can keep rotating the dataset of samples used in testing to respect the retention policy. The known benign samples from third party sources may include non-customer (e.g., publicly available) benign samples that have been hit by any of the function signatures generated (e.g., false positives of some function signatures).

In some embodiments, if a plurality of function signatures have a same ranking score, such as because they all have a same number of unique malware hits, then signature selection module 176 can resolve the conflict by selecting from the plurality of function signatures, the function signature having a longest length. The length of the function signature can be used as to resolve the ranking conflict (e.g., to break a tie in the number of unique malware hits) because the larger the length of the function signature, the less likely that the function signature will result in false positive. In some embodiments, the system is biased to select function signatures to reduce/eliminate false positives.

After selecting a set of non-discarded candidate function signatures (e.g., after determining a set of candidate function signatures provides sufficient coverage for the malware dataset from which the function signatures are generated), signature selection module 176 perform a large-scale retrospective scanning against a large dataset of labeled samples (e.g., benign files and/or malicious files). This large-scale scanning can be used to filter our candidate function signatures based on a determination of whether a candidate function signature performs a false positive detection in the large dataset of labeled samples (e.g., a large dataset stored in database 160). If signature selection module 176 determines that a candidate function signature results in a false positive detection for a sample in the large dataset of labeled samples, signature selection module 176 discards such function signature, and signature selection module 176 performs a replacement process in which a replacement function signature is selected to replace the discarded function signature (e.g., to provide coverage for the portion of the malware sample dataset that the discarded function signature was intended to cover). Signature selection module 176 can repeat the iterative process described above to select a replacement candidate function signature, which is then used to again scan against the large dataset of labeled samples. Conversely, if the candidate function signature does not result in a false positive detection for a sample in the large dataset of labeled samples, signature selection module 176 can provide the candidate function signature for deployment. For example, signature selection module 176 stores the candidate function signature (e.g., in database 160) and causes a deployment process to be implemented to deploy the function signature, which can include determining whether and/or how to deploy the function signature.

In some embodiments, malware signature management service 170 (e.g., signature selection module 176) deploys a selected subset of function signatures (e.g., the non-discarded candidate function signatures). In some embodiments, deployment of a particular function signature includes determining whether/how to deploy the function signature, such as based on a predefined criteria or based on a user input (e.g., selection by a domain expert). To deploy a function signature, malware signature management service 170 can determine a technique for performing detections using the function signature. For example, malware signature management service 170 determines a YARA rule for performing detections using the function signature. Various other techniques may be implemented, such as the use of other types of rules or heuristics, etc.

In some embodiments, deployment of a particular function signature includes first performing a shadow deployment of the function signature. For example, the system deploys (e.g., determines a YARA rule and configures the security service, such as a security entity, to use the YARA rule for detections) in a manner according to which the function signature is used to perform a detection, however, the detection is not used in production for traffic handling decisions or final verdicts. In this way, the system can monitor performance of the shadow-deployed function signature (e.g., determine whether the function signature results in any false positives) before release into production.

Malware signature management service 170 uses signature monitoring module 178 to monitor performance of a deployed function signature. Additionally, monitoring module 178 can be used to monitor the performance of a shadow-deployed function signature. Monitoring performance of a function signature includes collecting detections made using the function signature and determining whether any detection corresponds to a false positive detection.

In some embodiments, in response to determining via monitoring function signature deployment that a function signature results in a false positive, malware signature management service 170 can disable and/or discard the function signature. Additionally, malware signature management service 170 can cause a replacement function signature to be selected/implemented, such as by invoking signature selection module 176 to select another candidate function signature for deployment. In some embodiments, Malware signature management service 170 can additionally update the goodware dataset (e.g., the high priority goodware dataset used signature selection module 176 to select/evaluate candidate function signatures) to include the sample for which the discarded/disabled function signature resulted in a false positive.

According to various embodiments, security platform 140 may receive a query from a security entity (e.g., inline firewall, such as a next generation firewall) for a real-time or offline classification of a network traffic sample, such as a file.

According to various embodiments, in response to malicious traffic detection service 138 classifying the network traffic sample, system 100 handles the corresponding network traffic according to a predefined policy (e.g., a security policy). For example, in response to predicting that the network traffic sample corresponds to malicious network traffic, system 100 can cause the network traffic to be blocked or quarantined, etc. As another example, system 100 can cause traffic to/from a compromised host (e.g., the client system associated with the intercepted network traffic from which the malicious domain was extracted) to be quarantined or sinkholed, etc. (e.g., at least until an administrator actively configures system 100 to proceed with permitting traffic to/from the client system, such as in response to the compromised host being remediated).

According to various embodiments, in response to malicious traffic detection service 138 classifying the network traffic (e.g., the network traffic sample), system 100 handles the network traffic according to a predefined policy (e.g., a security policy). For example, the system queries a traffic handling policy to determine the manner by which the network traffic (e.g., network activity for a session associated with the network traffic sample) is to be handled. The traffic handling policy may be a predefined policy, such as a security policy, etc. The traffic handling policy may indicate that network traffic associated with certain domains or having certain characteristics/profiles is to be blocked and network traffic associated with other domains or having other characteristics/profiles is to be permitted to pass through the system (e.g., routed normally). The traffic handling policy may correspond to a repository of a set of policies to be enforced with respect to network traffic. In some embodiments, security platform 140 receives one or more policies, such as from an administrator or third-party service, and provides the one or more policies to various network nodes, such as endpoints, security entities (e.g., inline firewalls), etc.

In response to determining a classification for a newly analyzed network traffic sample (e.g., a newly analyzed network traffic sample for a particular session), security platform 140 (e.g., malicious traffic detection service 138) sends an indication that network activity (e.g., other network traffic samples) associated with the session for which the network traffic sample is obtained are associated with, or otherwise correspond to, the determined classification. In the case that the determined classification for the network traffic sample is that the corresponding network sample (e.g., a file extracted from the network traffic) or network traffic/activity is malicious network traffic/activity, security platform 140 provides an indication that network traffic/activity associated with the session for which the network traffic sample is obtained is also to be handled according to whether the network traffic sample is malicious. Security platform 140 can provide an indication that network traffic matching the network traffic sample predicted to be malicious is to be handled as a malicious network traffic. For example, security platform 140 determines (e.g., computes) a signature or identifier for the network traffic/activity (e.g., a hash or other signature, or identifier for the corresponding network session), and sends to a network node (e.g., a security entity, an endpoint such as a client device, etc.) an indication of the classification associated with the signature (e.g., an indication whether the network traffic/activity is a malicious or non-malicious). Security platform 140 may update a mapping of signatures to network traffic sample classifications and provide the updated mapping to the security entity. In some embodiments, security platform 140 further provides to the network node (e.g., security entity, client device, etc.) an indication of a manner by which network traffic/activity matching the network traffic sample or otherwise be associated with the same session as the network traffic sample classified as malicious or matching the signature is to be handled. For example, security platform 140 provides to the security entity a traffic handling policy, a security policy, or an update to a policy.

According to various embodiments, malicious traffic detection service 138 determines whether the network traffic sample has sufficient information with which to determine whether the network traffic activity (e.g., the network traffic associated with the session from which the network traffic sample is obtained) is malicious (e.g., to predict a maliciousness classification for the file sample or network traffic). In some embodiments, malicious traffic detection service 138 determines whether the network traffic sample has sufficient information with which to determine whether the network traffic activity based on a confidence associated with a maliciousness classification. For example, if the confidence for the predicted maliciousness classification is less than a predefined confidence threshold, malicious traffic detection service 138 can determine that the network traffic sample does not comprise sufficient information. Conversely, the confidence for the predicted maliciousness classification is greater than (or equal to or greater than) the predefined confidence threshold, malicious traffic detection service 138 (e.g., decision engine 152) can determine that the network traffic sample comprises sufficient information. In some embodiments, malicious traffic detection service 138 determines whether the network traffic sample comprises sufficient information based on one or more heuristics or other predefined rules.

In response to determining that the network traffic sample does not comprise sufficient information with which to classify the associated network traffic/activity, malicious traffic detection service 138 can cause the network traffic/activity associated with the network traffic sample to be monitored further. For example, malicious traffic detection service 138 instructs (e.g., provides an indication) to the security entity (e.g., an inline firewall) from which the network traffic sample is obtained to further monitor network traffic/activity for the corresponding session. In response to receiving an indication from malicious traffic detection service 138 to further monitor the network traffic/activity for the session associated with the network traffic sample, the security entity can continue to monitor the network traffic activity, identify network traffic samples, determine network traffic samples that are suspicious (e.g., detect suspicious network activity), and query security platform 140 for a further maliciousness classification.

According to various embodiments, in response to determining the maliciousness classification for a network traffic sample (e.g., obtaining the predicted maliciousness classification, such as from a classifier), malicious traffic detection service 138 provides an indication of the maliciousness classification, such as to the applicable security entity (e.g., the security entity that provided the network traffic sample or a security entity mediating network traffic for the session associated with the network traffic sample).

Returning to FIG. 1, suppose that a malicious individual (using client device 120) has created malware or malicious sample 130, such as a file, an input string, etc. The malicious individual hopes that a client device, such as client device 104, will execute a copy of malware or other exploit (e.g., malware or malicious sample 130), compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as C2 server 150, as well as to receive instructions from C2 server 150, as applicable.

As an illustrative example, the environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within network 110 as well as other devices, such as those located within other networks (e.g., networks 114 and 116)). DNS server 126 is publicly accessible but under the control of the malicious operator of C2 server 150. Enterprise DNS server 122 is configured to resolve enterprise domain names into IP addresses, and is further configured to communicate with one or more external DNS servers (e.g., DNS servers 124 and 126) to resolve domain names as applicable.

As mentioned above, in order to connect to a legitimate domain (e.g., www. example. com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C2 server 150, client device 104 will need to resolve the domain, “kj32hkjqfeuo32ylhkjshdflu23.badsite.com,” to a corresponding Internet Protocol (IP) address. In this example, malicious DNS server 126 is authoritative for *. badsite. com and client device 104's request will be forwarded (for example) to DNS server 126 to resolve, ultimately allowing C2 server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious network traffic, or otherwise determining that certain detected network traffic is to be further analyzed (e.g., using a finer detection model).

In some embodiments, security platform 140 comprises a network traffic classifier that provides to a security entity, such as data appliance 102, an indication of the traffic classification. For example, in response to detecting the C2 traffic, network traffic classifier sends an indication that the domain traffic corresponds to C2 traffic to data appliance 102, and the data appliance 102 may in turn enforce one or more policies (e.g., security policies) based at least in part on the indication. The one or more security policies may include isolating/quarantining the content (e.g., webpage content) for the domain, blocking access to the domain (e.g., blocking traffic for the domain), isolating/deleting the domain access request for the domain, ensuring that the domain is not resolved, alerting or prompting the user of the client device the maliciousness of the domain prior to the user viewing the webpage, blocking traffic to or from a particular node (e.g., a compromised device, such as a device that serves as a beacon in C2 communications), etc. As another example, in response to determining the application for the domain, the network traffic classifier provides to the security entity with an update of a mapping of signatures to applications (e.g., application identifiers).

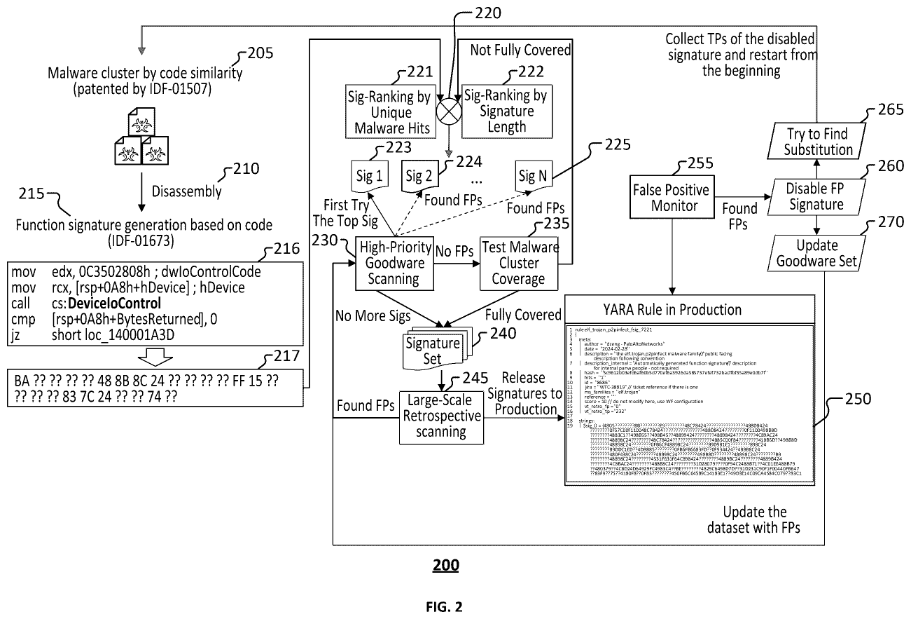

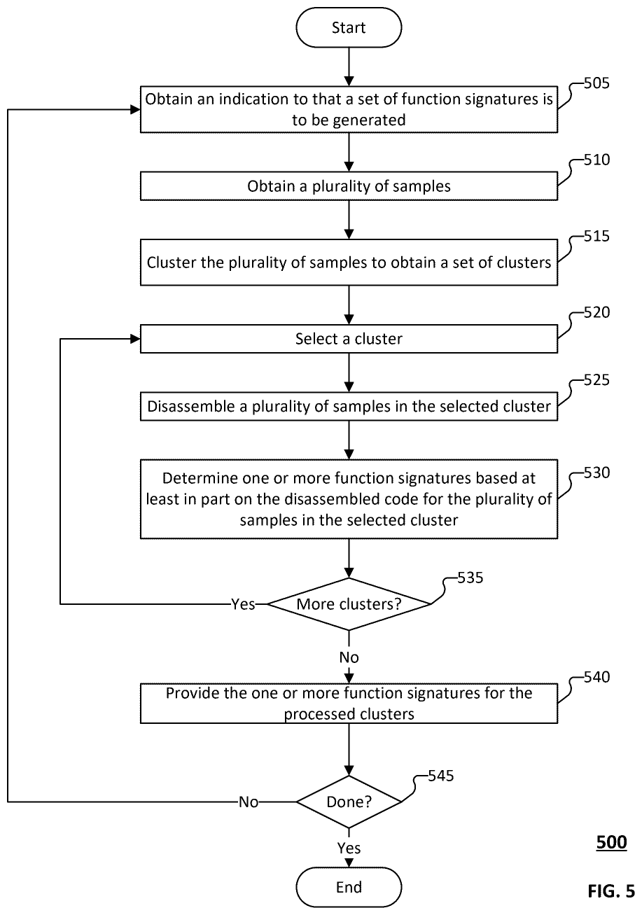

FIG. 2 is a flow diagram for automatically selecting a set of signatures detecting malware according to various embodiments. In various embodiments, process 200 is implemented in connection with one or more of systems 100 of FIG. 1, or one or more of processes 500-1200 of FIGS. 5-12.

Malware is evolving, so detection shall follow. To generate generic yet accurate detection for a new malware family, security services generally need to perform reverse engineering against the new malware family. However, manual reverse engineering is time-consuming and labor-intensive, which may cause late detection coverage. Therefore, various embodiments provide a systematic pipeline to automatically do reverse engineering and provide fast detection coverage for unseen malware. The pipeline generates assembly function signatures to identify the representative byte sequences in malware for detection. However, it is nontrivial to find a proper function signature. A good function signature for malware detection should be representative for a whole malware family; and it also should be accurate to avoid false positives. Balancing coverage/representation for a whole malware family and accuracy to limit false positives can be challenging. Various embodiments rely on big data to control the possibility of causing false positives.

To address the challenge of detecting malware that evades existing function signatures, the system is designed to collect malware samples directly from intercepted network traffic where no deployed function signatures have successfully made a true positive detection. This involves continuously monitoring network traffic in real time, flagging suspicious activities that bypass current detection methods. When abnormal patterns such as unusual data transfers, unexpected communication with external servers, or non-standard protocol usage are identified, the system isolates the relevant traffic for deeper inspection. Suspicious files or executables are extracted from the network packets and subjected to further analysis. Since these malware samples represent previously undetected threats, the system automatically processes them to determine new function signatures. Using machine learning and behavioral analysis, the system dissects the malware's code, functionality, and interactions, generating distinctive signatures that capture the unique characteristics of the malware. These newly generated signatures are then integrated into the system's detection framework to enhance its ability to identify and mitigate future attacks involving similar techniques or patterns.

At 205, the system collects malware sample dataset and clusters the malware samples in the malware sample set. As an example, the malware sample dataset (e.g., samples known to be malicious) can be obtained from a third party service (e.g., VirusTotal™, etc.) or from a security service (e.g., a security service that performs classifications from network traffic obtained/intercepted in the wild/production).

According to various embodiments, the system that takes as input a set of malware binaries and outputs a set of function signatures that can be used for detecting the input malware binaries. The system first performs disassembly on the input binaries to generate function signatures. Then, the input malware binaries are divided into clusters based on sample similarity.

The system can use various clustering techniques. In some embodiments, sample analysis module 172 implements the techniques (e.g., the clustering techniques) described in U.S. patent application Ser. No. 18/050,508 filed on Oct. 28, 2022, and published as U.S. Patent Application Publication No. 2024/0143753, the entirety of which is hereby incorporated by reference for all purposes.

At 210, the system disassembles the malware samples in the various malware clusters. For example, the system parses and disassembles the malware samples to obtain corresponding code. In some embodiments, in the disassembly process, functions are identified and disassembled. Function instructions can be converted to wildcarded byte sequences by replacing bytes that represent constant operands with question marks.

At 215, the system generates a function signature based on the code (e.g., the code obtained by disassembling the malware samples). In some embodiments, signature generation module 174 implements the techniques described in U.S. patent application Ser. No. 18/497,689 filed on Oct. 30, 2023, the entirety of which is hereby incorporated by reference for all purposes. For example, the system implements such techniques to generate function signatures for malware in the malware sample dataset.

According to various embodiments, the system obtains malware samples (e.g., sample. NET files), parses and disassembles the samples, performs a method transformation, and generates a DNSCodeHash for the malware sample. At 216, the method transformation can include transforming the Microsoft Intermediate Language (MSIL) code for each method into a corresponding uniformed format, which is then hashed. For example, for each MSIL instruction in a method, at 217, the system wildcards its operands so that each method becomes independent of the concrete data and the wildcarded representation can correspond to a signature of a method that is implemented by the malware.

At 220, the system selects potential candidate function signatures (e.g., first signature 223, second signature 224, and Nth signature 225, etc.). In some embodiments, the system selects the potential candidate function signatures on a malware cluster-by-malware cluster basis. For example, the system selects the potential candidate function signatures to determine a set of candidate function signatures that provide full coverage for each cluster in the set of malware clusters (e.g., the clusters obtained at 205).

According to various embodiments, for each cluster, the system uses a ranking based approach to select the best function signatures to detect the whole cluster, during which a high-priority goodware dataset is scanned for FP control. The system can instantiate a cluster of virtual machines to select potential function signatures for the respective malware clusters in parallel.

In some embodiments, the ranking based approach includes ranking function signatures (e.g., from the set of function signatures generated based on the malware sample dataset). The function signatures can be ranked according to a particular function signature characteristics or according to a function signature score determined according to a predefined scoring function. In the example shown, the system selects the potential function signature(s) based at least in part on the number of unique malware hits associated with a corresponding function signature (e.g., the number of malware samples from the malware sample dataset, or malware cluster, which can be detected by a particular function signature).

In connection with selecting potential candidate function signatures, at 221, the system determines (e.g., for each function signature in the set of generated function signatures) the number of unique malware hits associated with a corresponding function signature. At 222, the system determines a signature length for the function signatures (e.g., each function signature in the set of generated function signatures).

In some embodiments, the system ranks the function signatures according to their corresponding number of unique malware hits (e.g., from the malware sample dataset, or malware cluster). The system selects the potential candidate function signatures based on the ranking of function signatures, such as by selecting a highest ranked function signature (e.g., that has not previously been selected) or a predefined number if highest ranked function signatures. If a plurality of function signatures have a same number of unique malware hits, the system can use the signature length to resolve the conflict. For example, the system can select as the candidate function signature the function signature having a highest number of unique malware hits and that has a longest signature length of those function signatures having the same highest number of unique malware hits, if any.

In response to determining the potential candidate function signatures, at 230, the system evaluates the potential candidate function signature(s) against a goodware dataset, such as a dataset of high-priority goodware samples. For example, the system determines (e.g., for each potential candidate function signatures) whether a particular potential candidate function erroneously classifies a goodware sample in the goodware dataset. In some embodiments, the system determines whether the particular candidate function signature generates a false positive detection for a goodware sample comprised in the goodware dataset. If the system determines that a particular potential candidate function signature generates a false positive detection against the goodware dataset, the system can return to 2220 and select a new potential candidate function signature (e.g., based on the ranking). For example, the system discards the particular potential candidate function signature that generated a false positive detection and selects a next highest ranked function signature for the particular malware cluster for which the discarded potential candidate function provided coverage. If the system determines that the particular potential candidate function signature does not generate any false detections when evaluated against the goodware dataset, process 200 proceeds to 235 and/or 245.

At 235, the system tests the malware cluster coverage. For example, the system determines whether the malware sample dataset is sufficiently covered by the non-discarded candidate function signatures. In some embodiments, the system deems the malware sample dataset to be sufficiently covered if all malware clusters are covered by the non-discarded candidate function signatures. In some embodiments, the system deems the malware sample dataset to be sufficiently covered if all malware samples in all malware clusters are covered by the non-discarded candidate function signatures (e.g., if the malware clusters are fully covered). In response to determining that the malware cluster(s) is not sufficiently covered (e.g., fully covered), process 200 can return to 220 at which the system can select a new potential candidate function signature (e.g., a candidate function signature for the particular cluster that is not fully covered by non-discarded candidate function signatures.

Additionally, in response to determining that a particular potential candidate function signature(s) does not generate any false positives, at 240, the system stores the particular potential candidate function signature(s) as a candidate function signature in the signature set.

At 245, the system performs a large-scale retrospective scanning using the set of candidate function signatures (e.g., the set of function signatures stored at 240). The large-scale retrospective scanning includes using the candidate function signatures to classify (e.g., perform detections) against a large dataset of labeled samples. The large dataset of labeled samples can include known benign samples and/or known malicious samples. Eventually, the system automatically analyzes the retrospective scanning result to determine the FP-free and effective function signatures to be released for malware detection. Meanwhile, all the retrospective FPs are used to update the high-priority goodware dataset. In response to performing the large-scale retrospective scanning, the system discards any candidate function signatures that cause a false detection, and process 200 can return to 220 (e.g., at least for the cluster for which the discarded candidate function signature was to provide coverage) and iterate over 220-235 until sufficient coverage is achieved with replacement function signature(s). In some embodiments, the system discards the candidate function signature in response to determining that a false positive detection is generated with respect to the large dataset of labeled samples. In some implementations, false negative detections may be tolerated.

At 250, the system determines to deploy the function signature. The system can determine to deploy the function signature based at least in part on a predefined criteria and/or a user selection (e.g., a selection by a domain expert, etc.). In some embodiments, in connection with deploying the function signature, the system generates a YARA rule that is configured to use the function signature to classify network traffic sample (e.g., to detect malware in classified network traffic). In other embodiments, various other techniques may be used to implement the function signature to perform detections, such as determine heuristics based on the function signature, etc.

At 255, the system monitors the performance of deployed function signatures. For example, the system obtains detections or verdicts/classifications (e.g., each detection or verdict/classification) that are generated based on a particular function signature. In response to obtaining a detection or verdict/classification, the system determines whether the detection or verdict/classification is a false positive. If the detection or verdict/classification is not a false positive, then the system can continue the monitoring. In contrast, if the detection or verdict/classification by a particular function signature is a false positive, process 200 can proceed to 260 (while continuing to monitor performance of other function signatures.

According to various embodiment, the system keeps monitoring the released function signatures in production. If a function signature starts to hit FPs, the system will automatically disable the function signature and try to find a substitution for it.

At 260, the system disables the function signature that lead to a false positive. Thereafter, process 200 proceeds to 265 at which the system attempt to determine a replacement function signature. For example, process 200 proceeds to 220 at which the system iterates over 220-235 until a replacement candidate function signature is selected or no further feasible function signatures exist.

In some embodiments, the system can additionally update the goodware dataset (e.g., the set of high-priority goodware used at 230) to include the sample for which the disabled function signature generated the false positive detection or verdict/classification.

According to various embodiments, clustering the malware samples in the malware sample dataset is optional. In such an example, the system can treat all input malware binaries as one cluster.

In some embodiments, each cluster may be associated with one or more function signatures. For example, a subset of clusters may have a corresponding single function signature (e.g., a single function signature provides full coverage for the cluster). As another example, a subset of clusters may have a plurality of corresponding function signatures (e.g., multiple function signatures are needed to provide full coverage of a particular cluster). According to various embodiments, the system automatically finds the minimal number of function signatures to cover the whole malware cluster. For example, the system ranks the function signatures based on the signature length and the number of uniquely hit samples

FIG. 3 is a flow diagram of a method for automatically selecting function signatures for classifying network samples according to various embodiments. In some embodiments, process 300 is implemented at least in part by system 100 of FIG. 1. Process 300 may be implemented by a system (e.g., a cloud security platform) providing security service to an inline security entity, such as to a firewall (e.g., a next generation firewall). In some embodiments, process 300 implements at least part of process 200 of FIG. 2. In some embodiments, process 4300 00 is implemented by an inline security entity.

At 305, the system performs a disassembly of a plurality of input binaries to generate a set of function signatures.

At 310, the system determines a ranking of function signatures for the set of signatures.

At 315, the system automatically selects a subset of function signatures for classifying samples.

At 320, a determination is made as to whether process 300 is complete. In some embodiments, process 300 is determined to be complete in response to a determination that no further function signatures are to be deployed, no further function signatures are to be selected, no further monitoring of deployed function signatures is to be performed, an administrator indicates that process 300 is to be paused or stopped, etc. In response to a determination that process 300 is complete, process 300 ends. In response to a determination that process 300 is not complete, process 300 returns to 305.

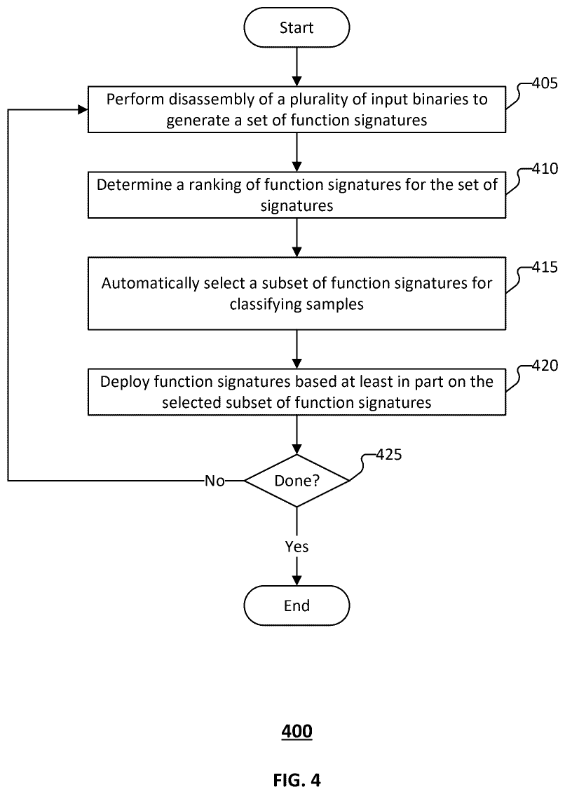

FIG. 4 is a flow diagram of a method for automatically selecting and deploying function signatures for classifying network samples according to various embodiments. In some embodiments, process 400 is implemented at least in part by system 100 of FIG. 1. Process 400 may be implemented by a system (e.g., a cloud security platform) providing security service to an inline security entity, such as to a firewall (e.g., a next generation firewall). In some embodiments, process 400 implements at least part of process 200 of FIG. 2. In some embodiments, process 400 is implemented by an inline security entity.

At 405, the system performs a disassembly of a plurality of input binaries to generate a set of function signatures. At 410, the system determines a ranking of function signatures for the set of signatures. At 415, the system automatically selects a subset of function signatures for classifying samples. At 530, the system deploys function signatures based at least in part on the selected subset of function signatures. At 25, a determination is made as to whether process 400 is complete. In some embodiments, process 400 is determined to be complete in response to a determination that no further function signatures are to be deployed, no further function signatures are to be selected, no further monitoring of deployed function signatures is to be performed, an administrator indicates that process 400 is to be paused or stopped, etc. In response to a determination that process 400 is complete, process 400 ends. In response to a determination that process 400 is not complete, process 400 returns to 405.

FIG. 5 is a flow diagram of a method for generating a set of function signatures for a set of samples according to various embodiments. In some embodiments, process 500 is implemented at least in part by system 100 of FIG. 1. Process 60500 0 may be implemented by a system (e.g., a cloud security platform) providing security service to an inline security entity, such as to a firewall (e.g., a next generation firewall). In some embodiments, process 6500 00 implements at least part of process 200 of FIG. 2. In some embodiments, process 60500 0 is implemented by an inline security entity. In some embodiments, process 500 is invoked by process 300, such as at 305, and/or process 400, such as at 405.

At 505, the system obtains an indication that a set of function signatures is to be generated.

At 510, the system obtains a plurality of samples.

At 515, the system clusters the plurality of samples to obtain a set of clusters.

At 520, the system selects a cluster, for example, from the set of clusters.

At 525, the system disassembles a plurality of samples in the selected cluster.

At 530, the system determines one or more function signatures based at least in part on the disassembled code for the plurality of samples in the selected cluster.

At 535, the system determines whether another cluster is to be evaluated for generation of one or more function signatures. For example, the system determines whether all of the clusters in the set of clusters have been processed, and if so, determines that no further clusters are to be evaluated. As another example, the system determines whether the function signatures determined for the processed clusters provide sufficient coverage across the set of clusters (e.g., that the system has already determined sufficient function signatures to provide detection for all clusters). In response to determining that another cluster(s) is to be evaluated, process 500 returns to 520 and iterates over 520-535 until no further clusters are to be evaluated. Conversely, in response to determining that no further clusters are to be evaluated, process 500 proceeds to 540.

At 540, the system provides the one or more function signatures for the processed clusters. In some embodiments, the system provides the one or more function signatures to the process, system, or service that invoked process 500.

At 545, a determination is made as to whether process 500 is complete. In some embodiments, process 500 is determined to be complete in response to a determination that no further function signatures are to be determined (e.g., because all the clusters have been performed, or because the system determines that the determined function signatures provide sufficient coverage of the collected malware samples), no further function signatures are to be deployed, no further function signatures are to be selected, no further monitoring of deployed function signatures is to be performed, an administrator indicates that process 6500 00 is to be paused or stopped, etc. In response to a determination that process 500 600 is complete, process 500 ends. In response to a determination that process 500 is not complete, process 500 returns to 505.

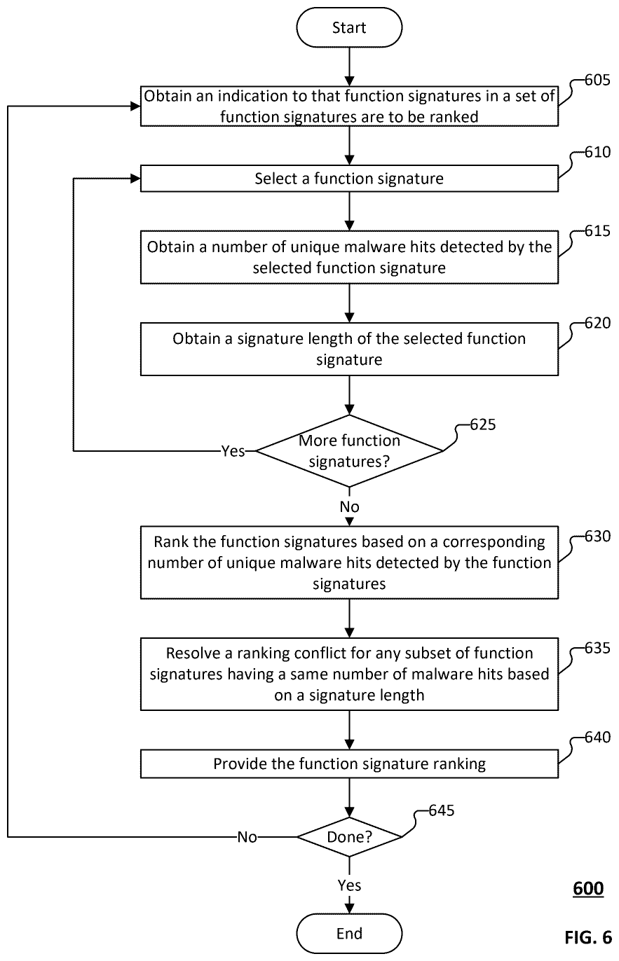

FIG. 6 is a flow diagram of a method for ranking function signatures according to various embodiments. In some embodiments, process 600 is implemented at least in part by system 100 of FIG. 1. Process 600 may be implemented by a system (e.g., a cloud security platform) providing security service to an inline security entity, such as to a firewall (e.g., a next generation firewall). In some embodiments, process 600 implements at least part of process 200 of FIG. 2. In some embodiments, process 600 is implemented by an inline security entity. In some embodiments, process 600 is invoked by process 300, such as at 310, and/or process 400, such as at 410.

At 605, the system obtains an indication that function signatures in a set of function signatures are to be ranked.

At 610, the system selects a function signature.

At 615, the system obtains a number of unique malware hits detected by the selected function signature.

At 620, the system obtains a signature length of the selected function signature.

At 625, the system determines whether another function signature(s) is to be processed. For example, the system determines whether the characteristics for each function signature in the set of function signatures. In response to determining that another function signature(s) is to be processed, process 600 returns to 610 and process 600 iterates over 610-625 until no further function signatures are to be processed. Conversely, in response determining that no further function signatures are to be processed, process 600 proceeds to 630.

At 630, the system ranks the function signatures based on a corresponding number of unique malware hits detected by the function signatures.

At 635, the system resolves a ranking conflict for any subset of function signatures having a same number of malware hits based on a signature length.

At 640, the system provides the function signature ranking. For example, the system provides the function signature ranking to a service that selects function signatures that are candidates for deployment. In some embodiments, the system provides the function signature ranking to the process, system, or service that invoked process 600.

At 645, a determination is made as to whether process 600 is complete. In some embodiments, process 600 is determined to be complete in response to a determination that no further function signatures are to be selected, no further function signatures are to be deployed, no further monitoring of the performance of deployed function signatures is to be performed, an administrator indicates that process 600 is to be paused or stopped, etc. In response to a determination that process 600 is complete, process 600 ends. In response to a determination that process 600 is not complete, process 600 returns to 605.

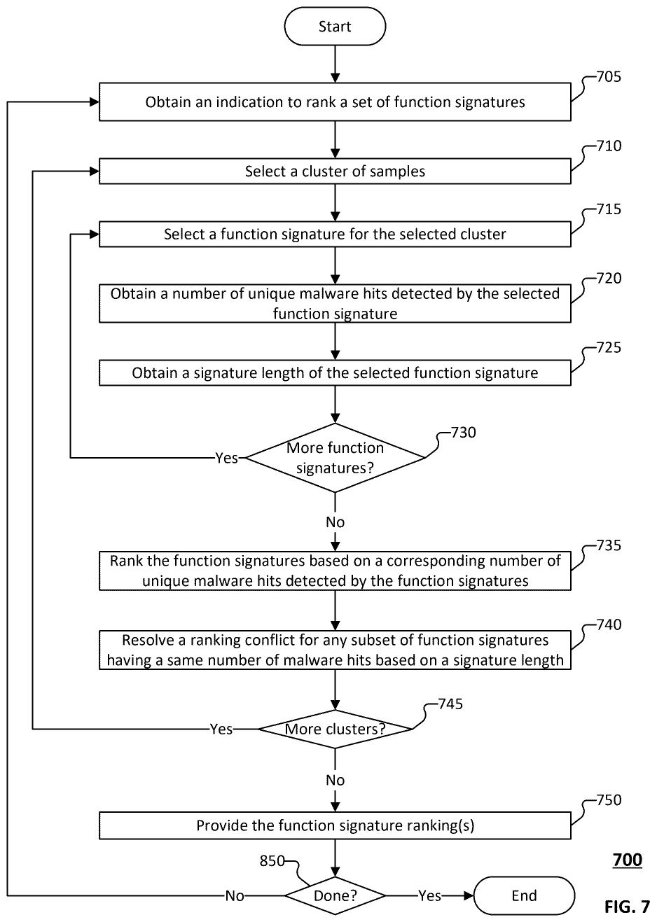

FIG. 7 is a flow diagram of a method for ranking function signatures according to various embodiments. In some embodiments, process 700 is implemented at least in part by system 100 of FIG. 1. Process 700 may be implemented by a system (e.g., a cloud security platform) providing security service to an inline security entity, such as to a firewall (e.g., a next generation firewall). In some embodiments, process 700 implements at least part of process 200 of FIG. 2. In some embodiments, process 700 is implemented by an inline security entity. In some embodiments, process 700 is invoked by process 300, such as at 310, and/or process 400, such as at 410.

At 705, the system obtains an indication to rank a set of function signatures.

At 710, the system selects a cluster of samples.

At 715, the system selects a function signature for the selected cluster.

At 720, the system obtains a number of unique malware hits detected by the selected function signature.

At 725, the system obtains a signature length of the selected function signature.

At 730, the system determines whether another function signature(s) is to be processed. For example, the system determines whether the characteristics for each function signature in the set of function signatures. In response to determining that another function signature(s) is to be processed, process 700 returns to 715 and process 700 iterates over 715-730 until no further function signatures are to be processed. Conversely, in response determining that no further function signatures are to be processed, process 700 proceeds to 735.

At 735, the system ranks the function signatures based on a corresponding number of unique malware hits detected by the function signatures.

At 740, the system resolves a ranking conflict for any subset of function signatures having a same number of malware hits based on a signature length.

At 745, the system determines whether another cluster(s) is to be processed. For example, the system determines whether any additional clusters require a function signature to be evaluated. As another example, the system determines whether the processed function signatures provide sufficient coverage for the malware samples. In response to determining that another cluster(s) is to be processed, process 700 returns to 710 and process 700 iterates over 710-745 until no further clusters are to be processed. Conversely, in response to determining that no further cluster(s) are to be processed, process 700 proceeds to 750.

At 750, the system provides the function signature rankings. In some embodiments, the system provides, for each cluster, a corresponding ranking of function signatures that provide coverage for that particular cluster. As an example, the system provides the function signature ranking to a service that selects function signatures that are candidates for deployment. In some embodiments, the system provides the function signature ranking to the process, system, or service that invoked process 700.

At 750, a determination is made as to whether process 700 is complete. In some embodiments, process 700 is determined to be complete in response to a determination that no further function signatures are to be selected, no further function signatures are to be deployed, no further monitoring of the performance of deployed function signatures is to be performed, an administrator indicates that process 700 is to be paused or stopped, etc. In response to a determination that process 700 is complete, process 700 ends. In response to a determination that process 700 is not complete, process 700 returns to 705.

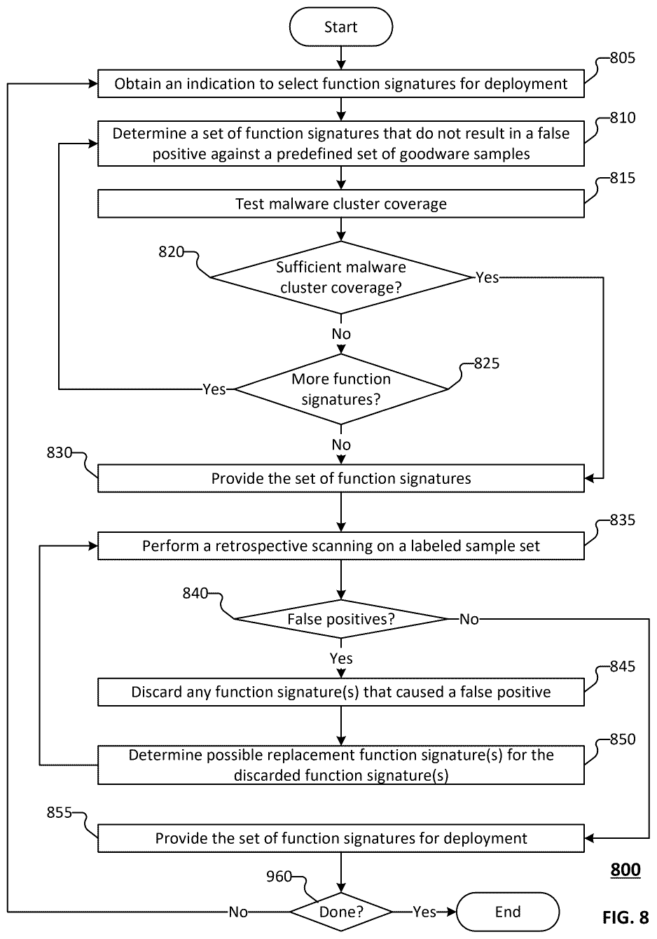

FIG. 8 is a flow diagram of a method for selecting function signatures for deployment according to various embodiments. In some embodiments, process 800 is implemented at least in part by system 100 of FIG. 1. Process 800 may be implemented by a system (e.g., a cloud security platform) providing security service to an inline security entity, such as to a firewall (e.g., a next generation firewall). In some embodiments, process 800 implements at least part of process 200 of FIG. 2. In some embodiments, process 800 is implemented by an inline security entity. In some embodiments, process 800 is invoked by process 300, such as at 315, and/or process 400, such as at 415.

At 805, the system obtains an indication to select function signatures for deployment.

At 810, the system determines a set of signatures that do not result in a false positive against a predefined set of goodware samples. For example, selects candidate function signatures based on a ranking of the function signatures generated based on a malware sample set. The candidate function signatures can be selected by selecting a set of candidate function signatures that optimize for a highest ranking and a broadest coverage against the malware sample set for which the function signatures were generated. The system can then run using the candidate function signatures against a dataset of goodware samples (e.g., samples known to be benign) to determine whether the select as the set of function signatures those candidate samples that did not result in a false positive when running detections against the dataset of goodware samples.

At 815, the system tests a malware cluster coverage. In some embodiments, the system evaluates the breadth of coverage of the malware sample set for which the set of function signatures can provide detections (e.g., true positives).

At 820, the system determines whether the set of function signatures results in a sufficient malware cluster coverage. As an example, the system deems the malware cluster to be sufficiently covered if all samples within the malware sample set are detected using the set of function signatures. In response to determining that the set of function signatures do not result in sufficient malware cluster coverage, process 800 proceeds to 825. Conversely, in response to determining the set of function signatures result in sufficient malware cluster coverage, process 800 proceeds to 830.

At 825, the system determines whether another function signature(s) is to be selected. For example, the system determines whether the function signatures generated for the malware sample set comprise any function signatures that were not selected but would expand the scope of malware cluster coverage. In response to determining that another function signature is to be selected, process 800 returns to 810 and process iterates over 810-825 until no further function signatures are to be selected. Conversely, in response to determining that no further function signatures are to be selected, process 800 proceeds to 830.

At 830, the system provides the set of function signatures. For example, the system stores the set of function signatures as candidate function signatures for deployment.

At 835, the system performs a retrospective scanning on a labeled sample set. The system uses the set of function signatures to perform detections against a dataset of malicious and benign files.

At 840, the system determines whether the detections made by the set of function signatures resulted in any false positives. In response to determining that no false positives were comprised in the detections using the set of function signatures, process 800 proceeds to 855 at which the provides the set of function signatures for deployment. For example, the system provides the set of function signatures for deployment to the system, process, or service that invoked process 800. Conversely, in response to determining that false positives were comprised in the detections using the set of function signatures, process 9800 00 proceeds to 845 at which the system discards any function signature(s) that caused a false positive detection. At 850, the system determines a possible replacement signature(s) for the discarded function signature(s). For example, the system determines whether function signatures generated for the malware sample set comprise any other function signatures that would cover at least part of the breadth of the malware clusters for which the discarded function signature was intended. Thereafter, process 800 returns to 835 and process iterates over 835-850 until the set of function signatures are determined not to generate any false positives. In each subsequent iteration, the system may only use the replacement function signatures to scan the labeled sample set for purposes of determining whether those replacement function signatures generate false positive detections.

At 860, a determination is made as to whether process 800 is complete. In some embodiments, process 800 is determined to be complete in response to a determination that no further probing timers are to be updated, no further application servers are deemed unavailable, an administrator indicates that process 800 is to be paused or stopped, etc. In response to a determination that process 800 is complete, process 800 ends. In response to a determination that process 800 is not complete, process 800 returns to 805.

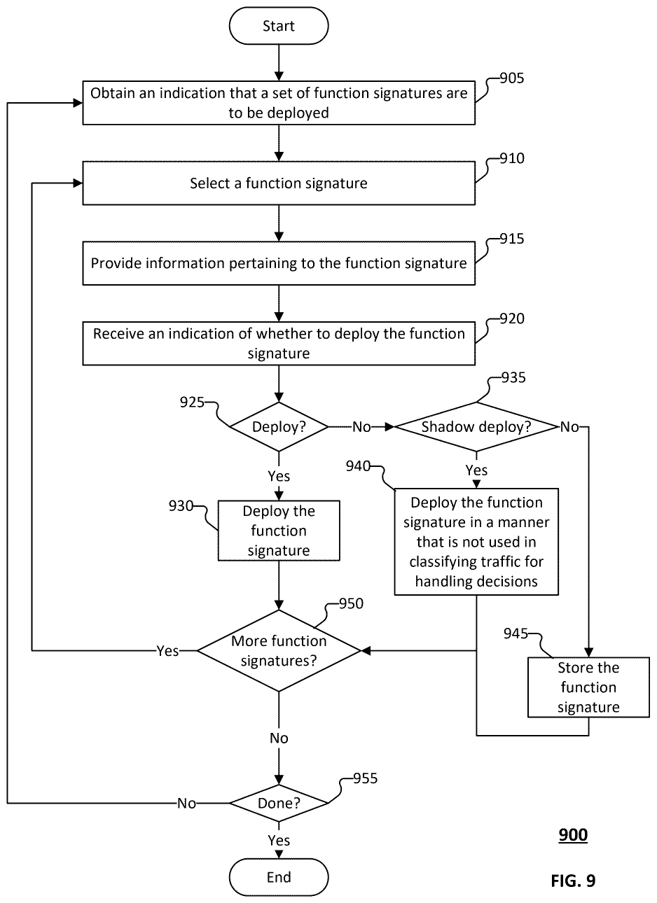

FIG. 9 is a flow diagram of a method for deploying a set of function signatures to perform network traffic classifications according to various embodiments. In some embodiments, process 900 is implemented at least in part by system 100 of FIG. 1. Process 900 may be implemented by a system (e.g., a cloud security platform) providing security service to an inline security entity, such as to a firewall (e.g., a next generation firewall). In some embodiments, process 900 implements at least part of process 200 of FIG. 2. In some embodiments, process 900 is implemented by an inline security entity. In some embodiments, process 900 is invoked by process 400, such as at 420.

At 905, the system obtains an indication to deploy a set of function signatures.

At 910, the system selects a function signature from the set of function signatures.

At 915, the system provides information pertaining to the function signature. In some embodiments, the system provides the information pertaining to the function signature to another system, service, or process in connection with requesting for an indication of whether the function signature is to be deployed. In some embodiments, the system provides the information pertaining to the function signature to a client system for an administrator or domain expert to manually select whether the function signature is to be deployed. In some embodiments, the system provides the information the information pertaining to the function signature another service or process that automatically determines whether to deploy the function signature, such as based on a predefined criteria (e.g., a detection rate, a false negative rate, another rule or heuristic such as a rule/heuristic defined by a domain expert, etc.). For example, the provides information pertaining to the function signature to another service or process, such as by invoking process 1000 to obtain an indication of whether to deploy the function.

At 920, the system receives an indication of whether to deploy the function signature. As an example, the system receives the indication of whether to deploy the function from a client system controlled by an administrator or domain expert that selects whether to deploy the function signature, or from another service or process that can automatically determine whether to deploy the function signature, etc.

At 925, the system determines whether the function signature is to be deployed based on the indication received at 920. For example, the system evaluates the indication or instruction received from another system, service, or process and determines whether the function signature is to be deployed.

In response to determining that the function signature is to be deployed, process 900 proceeds to 930 at which the system deploys the function signature. In some embodiments, deploying the function signature comprises providing an indication that the selected function signature is to be deployed. For example, the system provides (e.g., pushes) the function signature to security entities or network traffic classifiers to use in connection with detecting malware (e.g., detect malware from the intercepted network traffic).

In response to determining that the selected function signature is not to be deployed, process 900 proceeds to 935 at which the system determines whether the function signature is to be shadow deployed. For example, the system determines whether to provide the function signature to security entities or network traffic classifiers to classify file samples (e.g., files obtained by intercepted network traffic) but in a manner in which the detections made using such function signature is not used in determining a final verdict for the file samples (e.g., detections made using the function signature are not used in determining how to handle the file samples). In response to determining that the function signature is to be shadow deployed, the system deploys the function signature in a manner that the function signature is not used in classifying traffic for traffic handling decisions). For example, the system provides (e.g., pushes) the function signature to security entities or network traffic classifiers to use in connection with detecting malware (e.g., detect malware from the intercepted network traffic), but those security entities or network traffic classifiers do not use the function signatures in traffic handling decisions. Conversely, in response to determining that the function signature is not to be shadow deployed, process 900 proceeds to 945 at which the system stores the function signature, for example, to be used as a replacement function signature in the case that the system monitors another function signature as resulting in false positives.

At 950, the system determines whether another function signature is to be evaluated for deployment. For example, the system determines whether other candidate function signatures in the set of function signatures are to be evaluated for deployment. In response to determining that another function signature(s) is to be evaluated, process 900 returns to 910 and process 900 iterates over 910-950 until no further candidate function signatures are to be evaluated for deployment.

At 955, a determination is made as to whether process 900 is complete. In some embodiments, process 900 is determined to be complete in response to a determination that no further candidate function signatures are to be evaluated, no further candidate function signatures are to be deployed, an administrator indicates that process 900 is to be paused or stopped, etc. In response to a determination that process 900 is complete, process 900 ends. In response to a determination that process 900 is not complete, process 900 returns to 905.

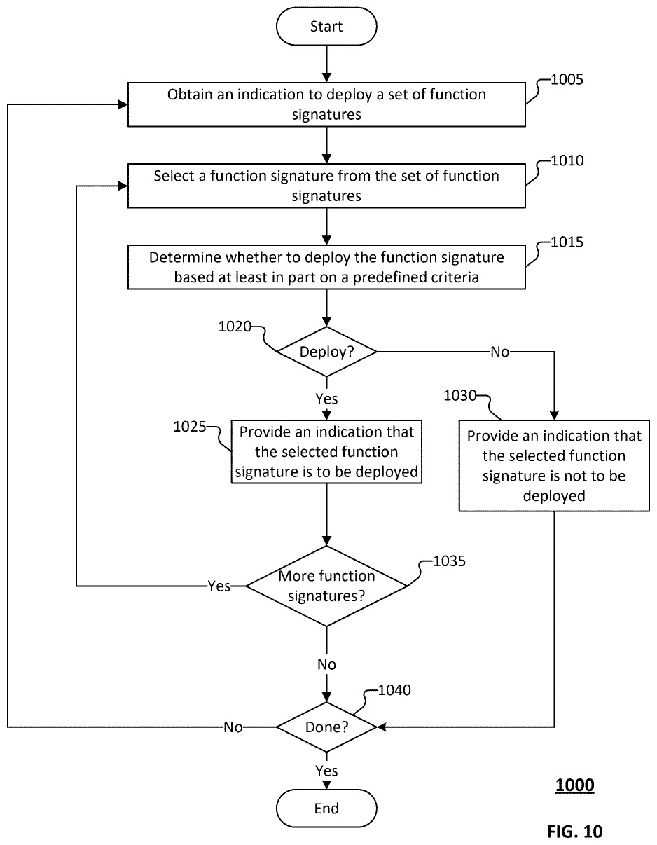

FIG. 10 is a flow diagram of a method for deploying a set of function signatures to perform network traffic classifications according to various embodiments. In some embodiments, process 1000 is implemented at least in part by system 100 of FIG. 1. Process 1000 may be implemented by a system (e.g., a cloud security platform) providing security service to an inline security entity, such as to a firewall (e.g., a next generation firewall). In some embodiments, process 1000 implements at least part of process 200 of FIG. 2. In some embodiments, process 1000 is implemented by an inline security entity. In some embodiments, process 1000 is invoked by process 400, such as at 420.

At 1005, the system obtains an indication to deploy a set of function signatures.

At 1010, the system selects a function signature from the set of function signatures.

At 1015, the system determines whether to deploy the function signature based at least in part on a predefined criteria. The predefined criteria can include one or more of (i) receiving an indication from a user such as a domain expert, (ii) a false negative rate being less than a predefined false negative threshold, (iii) a misclassification being less than a predefined threshold, etc.

At 1020, the system determines whether the function signature is to be deployed based on the determination at 1015. In response to determining that the function signature is to be deployed, process 1000 proceeds to 1025 at which the system provides an indication that the selected function signature is to be deployed. In response to determining that the selected function signature is not to be deployed, process 1000 proceeds to 1030 at which the system provides an indication that the function signature is not to be deployed. In some embodiments, the system provides the indication of whether the selected function signature is to be deployed to the process, system, or service that invoked process 1000.

At 1040, a determination is made as to whether process 1000 is complete. In some embodiments, process 1000 is determined to be complete in response to a determination that no further function signatures are to be deployed, an administrator indicates that process 1000 is to be paused or stopped, etc. In response to a determination that process 1000 is complete, process 1000 ends. In response to a determination that process 1000 is not complete, process 1000 returns to 1005.

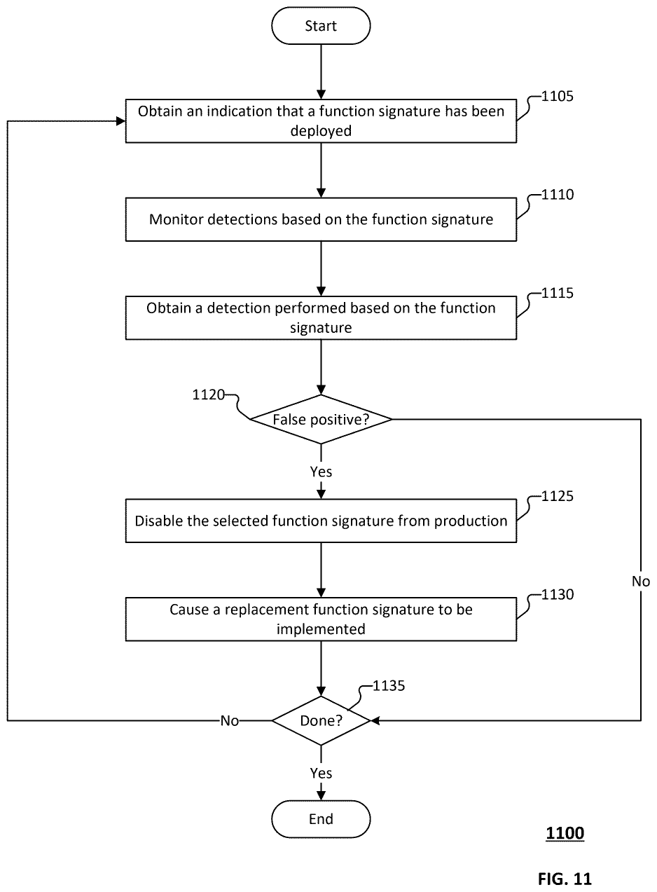

FIG. 11 is a flow diagram of a method for monitoring performance of a function signature for performing network traffic classifications after deployment according to various embodiments. In some embodiments, process 1100 is implemented at least in part by system 100 of FIG. 1. Process 1100 may be implemented by a system (e.g., a cloud security platform) providing security service to an inline security entity, such as to a firewall (e.g., a next generation firewall). In some embodiments, process 1100 implements at least part of process 200 of FIG. 2. In some embodiments, process 1100 is implemented by an inline security entity. In some embodiments, process 1100 is invoked by process 400, such as at 420.

At 1105, the system obtains an indication that a function signature is to be deployed. At 1110, the system monitors detections based on the function signatures. The system can intercept or receive detections made using the function signature. At 1115, the system obtains a detection performed based on the function signature. For example, the system obtains the various detections made by a security service (e.g., a security entity) by using the function signature. At 1120, the system determines whether the detection performed based on the function signature is a false positive. The system evaluates/analyzes the detections, such as to determine whether the detection is erroneous (e.g., is a false negative or a false positive) or correct (e.g., a true negative or a true positive). In response to determining that the detection using the function signature is not a false positive, process 1200 proceeds to 1235. Conversely, in response to determining that the detection made using the function signature is a false positive, process 1100 proceeds to 1125. At 1125, the system disables the selected function signature from production. For example, the system configures the system (or a security entity performing detections using the selected function signature) to not use the function signature in connection with determining a classification that is to be used in determining how to handle the file sample corresponding to the detection. Although the system can continue perform classifications using the function signature, the system does not use such classifications in determining verdicts for the sample. At 1130, the system causes a replacement function signature to be implemented. In some embodiments, causing the replacement function signature to be implanted determining whether any function signatures determined for the malware samples (e.g., the non-selected function signatures, such as lower ranked function signatures) provide the coverage with respect to the malware samples for which the disabled function signature had been deployed. For example, the system evaluates the non-selected function signatures to determine whether another function signature can detect malware for which the disabled function signature had been deployed, and if so, to deploy the signature. The deploying of the replacement signature can include invoking process 900 or 1000. At 1135, a determination is made as to whether process 1100 is complete. In some embodiments, process 1100 is determined to be complete in response to a determination that no further function signature monitoring is to be performed, an administrator indicates that process 1100 is to be paused or stopped, etc. In response to a determination that process 1100 is complete, process 1100 ends. In response to a determination that process 1100 is not complete, process 1100 returns to 1105.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
perform disassembly of a plurality of input binaries to generate a set of function signatures;
determine a ranking of function signatures for the set of function signatures;
automatically select a subset of function signatures for classifying samples, wherein the subset of function signatures is selected based at least in part on the ranking of function signatures; and
a memory coupled to the one or more processors and configured to provide the one or more processors with instructions.

2. The system of claim 1, wherein the set of function signatures comprise assembly function signatures.

3. The system of claim 1, wherein the type of file detected using the subset of function signatures comprises a family of files.

4. The system of claim 1, wherein one or more of the function signatures from the subset of function signatures is used to detect a malware family.

5. The system of claim 1, wherein the plurality of input binaries comprise a set of malware binaries.

6. The system of claim 1, wherein the one or more processors are further configured to:
obtain a plurality of clusters based at least in part on the plurality of input binaries.

7. The system of claim 6, wherein the plurality of clusters are determined based at least in part on performing a similarity clustering with respect to the plurality of input binaries.

8. The system of claim 6, wherein at least one function signature is automatically selected as a representative function signature for a particular cluster of the plurality of clusters.

9. The system of claim 1, wherein the one or more processors are further configured to:
deploy a particular function signature of the subset of function signatures in connection with detecting malware;
monitor sample classifications determined using the particular function signature; and
in response to determining that a sample classification determined using the particular function signature is a false positive, automatically disable the particular function signature as a detector of malware in a security system.

10. The system of claim 9, wherein a set of samples corresponding to false positive classifications using the particular function signature is added to a goodware dataset, and the goodware dataset is used to select function signatures for performing sample classifications.

11. The system of claim 9, wherein:
a particular function signature of the subset of function signatures is deployed in connection with detecting malware; and
in response to determining that the particular function signature provided a false positive detection, a replacement function signature is automatically selected based at least in part on the ranking of function signatures.

12. The system of claim 1, wherein the one or more YARA rules are determined based at least in part on the subset of function signatures.

13. The system of claim 12, wherein the one or more YARA rules are deployed at a security platform or security service.

14. The system of claim 12, wherein the one or more YARA rules is deployed at a security platform to detect malware.

15. The system of claim 12, wherein the one or more YARA rules are updated periodically or in response to a predefined criteria being satisfied.

16. The system of claim 12, wherein the predefined criteria is a malware detection based on a particular YARA rule is a false positive.

17. The system of claim 12, wherein a particular YARA rule is deployed in production for a security platform in response to determining that a number of sample classifications using a corresponding function signature has satisfied a predefined threshold of true positive classifications.

18. The system of claim 12, wherein the one or more processors are further configured to:
determine that a subset of YARA rules of the one or more YARA rules is to be released as a test rule used in testing a classifying samples intercepted by a security entity without impacting a particular sample classification during production.

19. The system of claim 1, wherein the plurality of input binaries comprises an input binary for a Windows PE file, or an Executable and Linkable Format (ELF) file.

20. A method, comprising:
performing disassembly of a plurality of input binaries to generate a set of function signatures;
determining a ranking of function signatures for the set of function signatures; and
automatically selecting a subset of function signatures for classifying samples, wherein the subset of function signatures is selected based at least in part on the ranking of function signatures.

21. A computer program product embodied in a non-transitory computer readable medium and comprising computer instructions for:
performing disassembly of a plurality of input binaries to generate a set of function signatures;
determining a ranking of function signatures for the set of function signatures; and
automatically selecting a subset of function signatures for classifying samples, wherein the subset of function signatures is selected based at least in part on the ranking of function signatures.
